(19) United States
(12) Patent Application Publication
(10) Pub. No.: US 2026/0233669 A1
(43) Pub. Date: Aug. 13, 2026

(54) VEHICLE LOAD INDICATOR UTILIZING AT LEAST ONE STEP LAMP

(71) Applicant: Ford Global Technologies, LLC, Dearborn, MI (US)

(72) Inventors: Stuart C. Salter, White Lake, MI (US); Jeffrey Robert Seaman, Petersburg, MI (US); Dawn Piechocki, Grosse Pointe Park, MI (US); Jenna Rogers, Canton, MI (US); Katherine Rouen, Northville, MI (US); Neil Lawson Overgaard, Ypsilanti, MI (US)

(21) Appl. No.: 19/049,332

(22) Filed: Feb. 10, 2025

(51) Int. Cl. B60Q 1/50; B60Q 1/30; F21S 10/06; F21W 102/40

(52) U.S. Cl. CPC B60Q 1/543; B60Q 1/30; F21S 10/06; F21W 2102/40

(57) ABSTRACT

A vehicle load indicator method includes, under first operating conditions, activating a step lamp of a vehicle to illuminate a step surface of a vehicle with a step lamp and, under second operating conditions, adjusting an activating of the step lamp to provide information about a load within the vehicle.

### TECHNICAL FIELD

This disclosure relates generally to providing a user with information about a vehicle load and, more particularly to using at least one step lamp of the vehicle to provide that information.

### BACKGROUND

Some vehicles are capable of providing information about loads carried by a vehicle. The loads can be cargo that is added to the vehicle. In the past, information about loads could be shared with a user through on a passenger compartment display, on a device, such as a user’s smartphone, or by illuminating taillights of the vehicle.

### SUMMARY

In some aspects, the techniques described herein relate to a vehicle load indicator method, including: under first operating conditions, activating a step lamp of a vehicle to illuminate a step surface of a vehicle with a step lamp; and under second operating conditions, adjusting an activating of the step lamp to provide information about a load within the vehicle.

In some aspects, the techniques described herein relate to a vehicle load indicator method, wherein adjusting the activating includes adjusting an intensity of light emitted from the step lamp.

In some aspects, the techniques described herein relate to a vehicle load indicator method, wherein adjusting the activating includes blinking the step lamp.

In some aspects, the techniques described herein relate to a vehicle load indicator method, wherein adjusting the activating of the step lamp includes blinking the step lamp at a faster rate in response to the load increasing.

In some aspects, the techniques described herein relate to a vehicle load indicator method, further including, when the load is at or above a threshold load, stopping the blinking and maintaining activation of the step lamp.

In some aspects, the techniques described herein relate to a vehicle load indicator method, wherein the step lamp is a driver side step lamp and further including adjusting an activating of a passenger side step lamp to instead or additionally convey information about the load within the vehicle.

In some aspects, the techniques described herein relate to a vehicle load indicator method, further including activating the driver side step lamp differently from the passenger side step lamp to indicate that the load is an imbalanced load.

In some aspects, the techniques described herein relate to a vehicle load indicator method, wherein adjusting the activating includes blinking the driver side step lamp and blinking the passenger side step lamp at different rates when an amount of the load on a driver side of the vehicle is different than amount of the load on a passenger side of the vehicle.

In some aspects, the techniques described herein relate to a vehicle load indicator method, wherein the vehicle is a pick-up truck and the step is at a rear of the vehicle.

In some aspects, the techniques described herein relate to a vehicle load indicator method, wherein the step is at a rear corner of the vehicle.

In some aspects, the techniques described herein relate to a vehicle load indicator method, further including activating a sound exciter of the vehicle to provide information about the load within the vehicle.

In some aspects, the techniques described herein relate to a vehicle load indicator method, wherein the step lamp is illuminating the step during the activating of the step lamp to provide information about a load within the vehicle.

In some aspects, the techniques described herein relate to a vehicle load indicator method, further including under first operating conditions, activating the step lamp of a vehicle in response to the vehicle detecting movement.

In some aspects, the techniques described herein relate to a vehicle load indicator system, including: a cargo area of a vehicle; a step to the cargo area; and a light that activates to illuminate the step, the light selectively activated in response to a load within the cargo area.

In some aspects, the techniques described herein relate to a vehicle load indicator system, further including an electronic control unit that activates the light in response to the load.

In some aspects, the techniques described herein relate to a vehicle load indicator system, further including a sound exciter, the electronic control unit additionally activating the sound exciter in response to the load.

In some aspects, the techniques described herein relate to a vehicle load indicator system, wherein the electronic control unit is a body control module.

In some aspects, the techniques described herein relate to a vehicle load indicator system, wherein the light is a driver side step light and the step is a driver side step, and further including a passenger side step light that activates to illuminate a passenger side step, the passenger side step light selectively activate in response to the load within the cargo area.

In some aspects, the techniques described herein relate to a vehicle load indicator system, wherein the driver side step and the passenger side step are on opposing rear corners of the vehicle.

In some aspects, the techniques described herein relate to a vehicle load indicator system, wherein an electronic control unit of the vehicle activates the driver side step light differently from the passenger side step light to indicate an imbalanced load within the cargo area.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a rear view of an example vehicle having a load indicator system that utilizes at least one step lamp of the vehicle.

FIG. 2 illustrates a perspective view of the vehicle of FIG. 1.

FIG. 3 illustrates a highly schematic view of the vehicle of FIGS. 1 and 2.

FIG. 4 illustrates a flow of an example load indicating method utilized by the vehicle of FIG. 1.

### DETAILED DESCRIPTION

This disclosure relates generally to vehicles that carry loads and, in particular, to a load indicator method and system for the vehicle. The method and system can utilize one or more step lamps of vehicle, which are separate and distinct from taillights on the vehicle. The step lamps, when activated, can illuminate a step utilized to access a cargo bed or other area of the vehicle. As the step lamps are load indicators, taillamps of the vehicle do not need to incorporate load indicators.

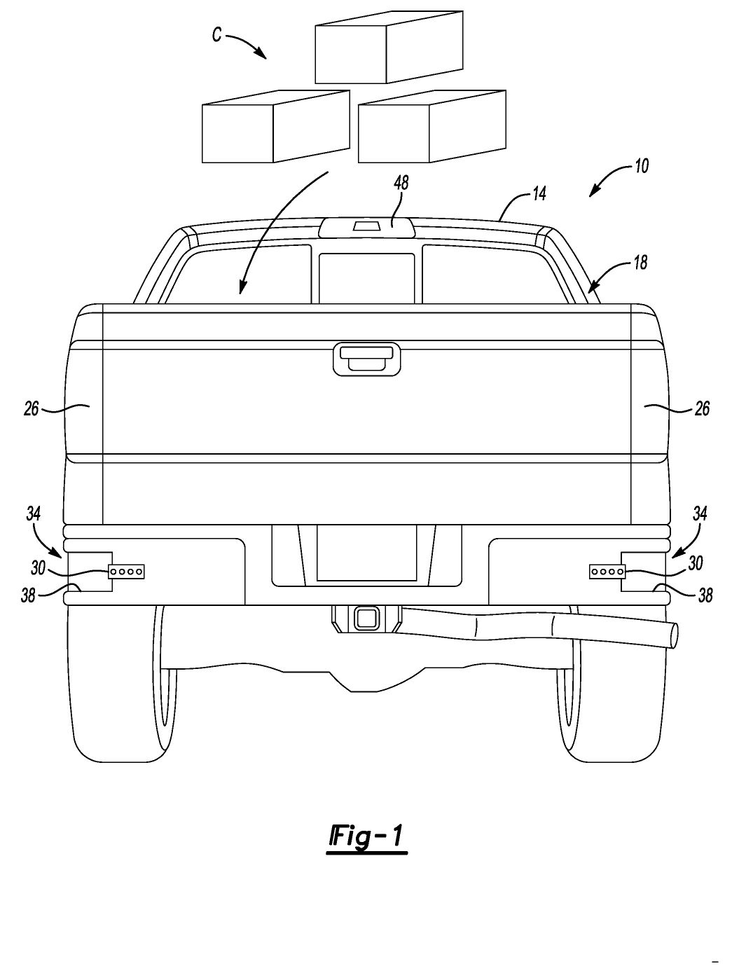

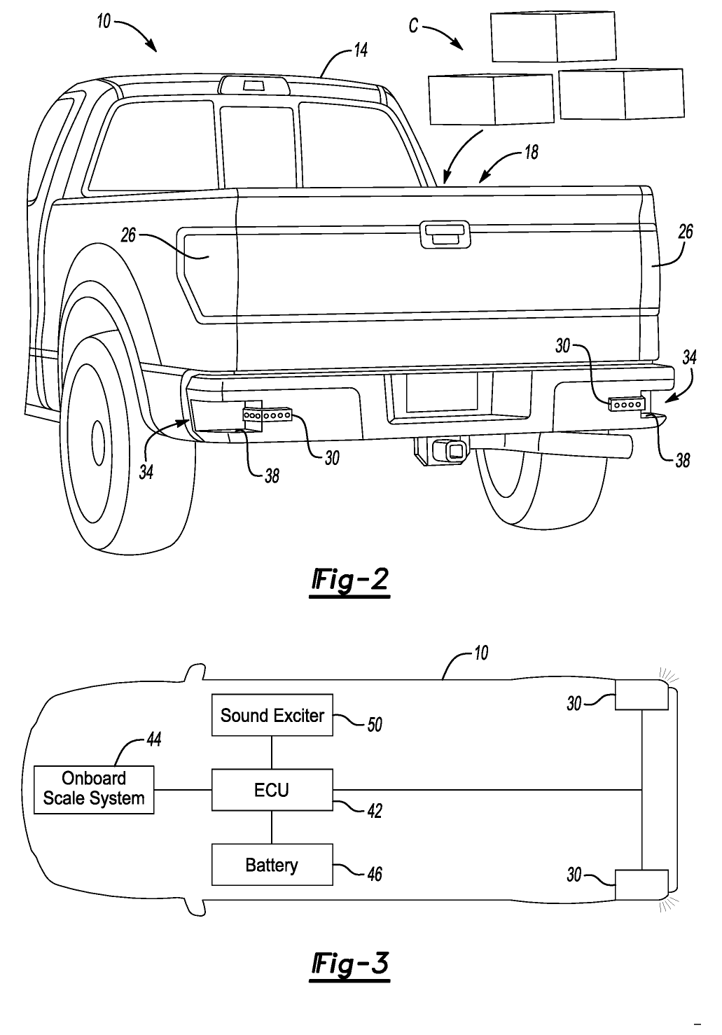

With reference to FIGS. 1–3, a vehicle 10 includes a passenger compartment 14 and a cargo area 18. The example vehicle 10 is a pickup truck, and the cargo area 18 is provided by a cargo bed. The cargo area could be something other than a cargo bed of a pickup in other examples.

The vehicle 10 includes a pair of taillamps 26, and a pair of step lamps 30. The example vehicle 10 includes a pair of steps 34. One of the steps 34 is at a rear, driver side corner of the vehicle 10. The other of the steps 34 is at a rear, passenger side corner of the vehicle 10. While the step lamps 30 and steps 34 are shown at the rear corner areas of the vehicle 10, the step lamps 30 could be positioned elsewhere in other examples.

In this example, the steps 34 are recesses within a rear bumper 36 of the vehicle 10. The steps 34 include a step surface 38. A user can step onto one of the step surfaces 38 to help the user access the cargo area 18.

The step lamps 30 are positioned, in the exemplary embodiment, vertically above the associated step surface 38 and oriented such that, when activated, the step lamp 30 emits light onto the step surface 38. Light emitted from the step lamps 30 illuminates, among other things, the associated step surfaces 38. Vertical, for purposes of this disclosure, is with reference to ground and general orientation of the vehicle 10 during operation.

The step lamps 30 are separate and distinct from the taillamps 26. The taillamps 26 are not step lamps 30 because, among other things, the taillamps 26, when activated, would not emit light suitable for illuminating the step surfaces 38 step surface.

The vehicle 10 includes an electronic control unit (ECU) 42 operably connected to the step lamps 30. In this example, the ECU 42 is a body control module (BCM).

The ECU 42 can activate one or both of the step lamps 30. Activate, for purposes of this disclosure, means powering the step lamp 30 such that the step lamp 30 emits light. The step lamps 30 can be powered by an accessory battery 46 of the vehicle 10.

The ECU 42 can activate one or both of the step lamps 30 in response to a user approaching the vehicle, in response to a user input, at a particular time of day, etc. As can be appreciated, illuminating the step surfaces 38 can help a user locate and utilize the step surface 38.

In some examples, the step lamps 30 can be activated manually when a user actuates a step lamp switch, which could be in the cargo area 18 of the vehicle 10.

The step lamps 30 can be assemblies that incorporate one more individual lights that provide a side marker light, a reverse white light, etc. These individual lights can be selectively activated as required.

The example vehicle 10 is equipped with an onboard scale system 44, which can monitor loads added to the cargo area 18 and to other areas of the vehicle 10. A person having skill in this art and the benefit of this disclosure would understand how to equip the vehicle 10 with an onboard scale system. In some examples, the onboard scale system 44 can receive input information from suspension height sensors, and then rely on this information to estimate a payload.

In the past, taillamps of vehicles have been activated to reveal information obtained from the onboard scale system. Incorporating such functionality into taillamps can introduce complexity into the taillamps. The step lamps 30 typically require less power to illuminate than other lamps, such as puddle lamps, taillamps, etc.

In an exemplary embodiment of this disclosure, a load indicator method and system relies on the step lamps 30 to reveal information about loads added to the vehicle 10—information that can be obtained from the onboard scale system 44.

Under first operating conditions when the vehicle 10 is not being loaded with cargo, the step lamps 30 can be activate to illuminate the step surface 38 associated with those step lamps 30. Under other, second operating conditions, such as when a user is loading the vehicle 10, the ECU 42 can obtain information about the load from the onboard scale system 44, and, in response, adjust an activating of one or both of the step lamps 30 to provide information about the load. The adjusting can include, turning on the step lamps 30, blinking or flashing the step lamps 30, changing an intensity of light emitted from the step lamps 30, etc.

For example, as cargo C is added to the cargo area 18, the load carried by the vehicle 10 increases. The ECU 42 receives an input from the onboard scale system indicating that the load is increasing. In response, the ECU 42 can activate the step lamps 30. The ECU 42 can activate the step lamps 30 at a relatively low intensity when cargo C is first added to the cargo area 18, and then increase an intensity of light emitted from the step lamps 30 in response to additional cargo C being added to the cargo area 18.

If cargo C continues to be added such that the load reaches a threshold load level, such as a level that is within twenty percent of a load carrying capacity for the vehicle 10, the ECU 42 can activate one or both of the step lamps 30 to blink. The blinking of the step lamps 30 provides a visual indication to the user that the load within the vehicle 10 is approaching load carrying capacity for the vehicle 10.

A rate of the blinking of the step lamps 30 can increase as additional cargo C is added to the vehicle 10. Blinking the step lamps 30 at a faster rate in response to the load increasing visually shows that the load carried by the vehicle 10 is increasing.

When the load is within say five percent of a load carrying capacity for the vehicle 10, the ECU 42 stops blinking the step lamps 30 and maintains the step lamps 30 in an active state at a high intensity. This can notify the user that the vehicle 10 has nearly reached a load carrying capacity.

In some examples a center high-mounted stop lamp (CHMSL) 48 for the vehicle 10 can be activated by the ECU 42 in connection with the step lamps 30 to reveal indication about loads being added to the vehicle 10.

In some examples, a load indicator method and system of the vehicle 10 can detect that the load is imbalanced within the vehicle 10 and then indicate that the load is imbalanced. If, for example, a load within the cargo area 18 is imbalanced such that there is more weight on a driver side of the vehicle 10 than the passenger side of the vehicle 10, the ECU 42 can activate the step lamp 30 on the driver side and the step lamp 30 on the passenger side to blink at different rates to indicate that the load is imbalanced. The

In addition to activating the step lamps 30 to reveal information about loads added to the vehicle 10, a load indicator method and system can rely on the ECU 42 can instead or additionally activate a sound exciter 50 of the vehicle 10. The sound exciter 50 could be a speaker, for example. In some examples, the sound exciter 50 can receive spoken commands from a user.

The sound exciter 50 can announce an amount of the load, an amount of load carrying capacity remaining before the vehicle 10 reaches a load carrying capacity, etc.

If load being added to the vehicle 10 is a plurality of similar items that increase the load by set increments, the sound exciter 50 can be activated by the ECU 42 to announce how many more of those items can be added to the vehicle 10 before the vehicle 10 reaches its load carrying capacity.

For example, when the cargo C is added in similar increments, such as similar bags of salt or similar bundles of paver stones being added to the cargo area 18, the sound exciter 50 could, for example, announce “eight items remaining” if adding eight more of those items would cause the vehicle 10 to reach a particular load. After the user adds a few more items, the ECU 42 can recognize the change in the load and announce, for example, “six items remaining.”

In some examples, the ECU 42 can also activate the sound exciter 50 to announce how much towing capacity the vehicle 10 may have after loads have been added to the cargo area 18 or elsewhere within the vehicle 10.

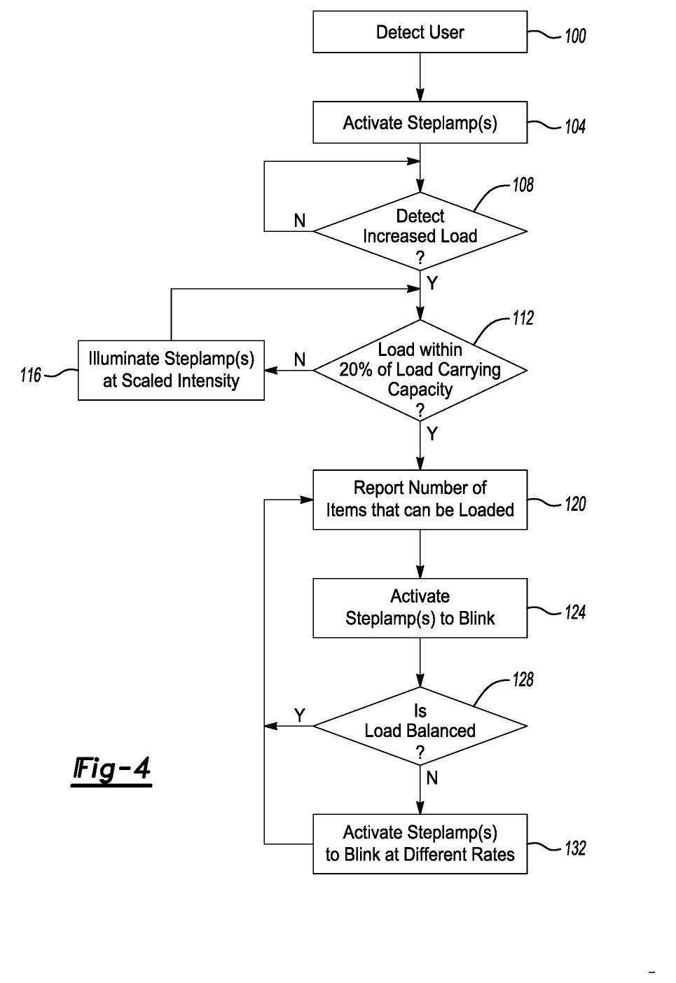

With reference now to FIG. 4 and continuing reference to FIGS. 1–3, an example vehicle load indicator method used in connection with the vehicle 10 begins when the vehicle 10 detects movement of a user toward the vehicle 10 at a step 100. In response to detecting the user, the ECU 42 activates one or both of the step lamps 30 at a step 104.

Next, at a step 108, the method detects whether or not items have been added to the vehicle 10, which increases the load carried by the vehicle 10. The method can rely on the onboard scale system 44 of the vehicle 10 to detect the increased load.

After detecting that load has increased, the method moves to the step 112 which assess whether or not the item loaded into the vehicle 10 brings the total load carried by the vehicle 10 to be within say twenty-percent of the load carrying capacity for the vehicle 10.

If not, the method moves to the step 116, which illuminates the step lamps 30 at an intensity scaled to correspond generally to the load carried by the vehicle 10 compared to the load carrying capacity of the vehicle 10. For example, if the load carried by the vehicle 10 is fifty-percent of the load carrying capacity of the vehicle 10, the ECU 42 can illuminate the step lamps 30 at fifty-percent of the potential intensity of the step lamps 30.

At the step 112, if the item loaded to the vehicle 10 brings the load carried by the vehicle to be within twenty-percent of the load carrying capacity for the vehicle 10, the method moves to the step 120 where the method can report out how many more items can be loaded to the vehicle 10. This information can be relayed utilizing the sound exciter 50 as previously described.

The method can then move to a step 124 where the ECU 42 activates the step lamps 30 to blink. A rate at which the step lamps 30 blink can change based on how close the load is to the load carrying capacity of the vehicle 10.

From the step 124, the method then moves to a step 128 which assesses whether or not the load within the vehicle 10 is within twenty-percent of being balanced. That is, is the load on a driver’s side of the vehicle within twenty-percent of the load on the passenger side of the vehicle. If yes, the method moves back to the step 124. If no, the method moves to the step 132 where the ECU 42 activates the step lamp 30 on a passenger side of the vehicle 10 to blink at a different rate than the step lamp 30 on a driver’s side of the vehicle 10.

This difference in the rate of activation or blinking can reveal to a user that the load within the vehicle 10 is imbalanced. If the user shifts the load within the vehicle 10 to become more balanced, the ECU 42 can change the rate of blinking of the step lamp 30 on the passenger side to be closer to a rate of blinking of the step lamp 30 on the driver’s side. This can reveal to the user that the load is more balanced.

Features of the disclosed examples include activating step lamps provide information to a user about loads added to a vehicle. Activating the step lamps can reveal information about remaining load carrying capacity for the vehicle, as well as load imbalances within the vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle load indicator method, comprising:
under first operating conditions, activating a step lamp of a vehicle to illuminate a step surface of a vehicle with a step lamp; and
under second operating conditions, adjusting an activating of the step lamp to provide information about a load within the vehicle.

2. The vehicle load indicator method of claim 1, wherein adjusting the activating includes adjusting an intensity of light emitted from the step lamp.

3. The vehicle load indicator method of claim 1, wherein adjusting the activating includes blinking the step lamp.

4. The vehicle load indicator method of claim 2, wherein adjusting the activating of the step lamp includes blinking the step lamp at a faster rate in response to the load increasing.

5. The vehicle load indicator method of claim 4, further comprising, when the load is at or above a threshold load, stopping the blinking and maintaining activation of the step lamp.

6. The vehicle load indicator method of claim 1, wherein the step lamp is a driver side step lamp and further comprising adjusting an activating of a passenger side step lamp to instead or additionally convey information about the load within the vehicle.

7. The vehicle load indicator method of claim 6, further comprising activating the driver side step lamp differently from the passenger side step lamp to indicate that the load is an imbalanced load.

8. The vehicle load indicator method of claim 6, wherein adjusting the activating includes blinking the driver side step lamp and blinking the passenger side step lamp at different rates when an amount of the load on a driver side of the vehicle is different than amount of the load on a passenger side of the vehicle.

9. The vehicle load indicator method of claim 1, wherein the vehicle is a pick-up truck and the step surface is at a rear of the vehicle.

10. The vehicle load indicator method of claim 1, wherein the step surface is at a rear corner of the vehicle.

11. The vehicle load indicator method of claim 1, further comprising activating a sound exciter of the vehicle to provide information about the load within the vehicle.

12. The vehicle load indicator method of claim 1, wherein the step lamp is illuminating the step during the activating of the step lamp to provide information about a load within the vehicle.

13. The vehicle load indicator method of claim 1, further comprising under first operating conditions, activating the step lamp of a vehicle in response to the vehicle detecting movement.

14. A vehicle load indicator system, comprising:
a cargo area of a vehicle;
a step to the cargo area; and
a light that activates to illuminate the step, the light selectively activated in response to a load within the cargo area.

15. The vehicle load indicator system of claim 14, further comprising an electronic control unit that activates the light in response to the load.

16. The vehicle load indicator system of claim 15, further comprising a sound exciter, the electronic control unit additionally activating the sound exciter in response to the load.

17. The vehicle load indicator system of claim 15, wherein the electronic control unit is a body control module.

18. The vehicle load indicator system of claim 14, wherein the light is a driver side step light and the step is a driver side step, and further comprising a passenger side step light that activates to illuminate a passenger side step, the passenger side step light selectively activate in response to the load within the cargo area.

19. The vehicle load indicator system of claim 18, wherein the driver side step and the passenger side step are on opposing rear corners of the vehicle.

20. The vehicle load indicator system of claim 18, wherein an electronic control unit of the vehicle activates the driver side step light differently from the passenger side step light to indicate an imbalanced load within the cargo area.
